(19) United States
(12) Patent Application Publication
(10) Pub. No.: US 2024/0211606 A1
(43) Pub. Date: Jun. 27, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Itaru HOSOMI, Tokyo (JP); Satoshi Ikeda, Tokyo (JP); Yusuke Takahashi, Tokyo (JP); Shohei Hiruta, Tokyo (JP)

(73) Assignee: NEC Corporation, Tokyo (JP)

(21) Appl. No.: 18/390,047

(22) Filed: Dec. 20, 2023

(30) Foreign Application Priority Data
Dec. 26, 2022 (JP) 2022-208773

(51) Int. Cl. G06F 21/57

(52) U.S. Cl. CPC G06F 21/577; G06F 2221/034

(57) ABSTRACT

An information processing apparatus includes: a trace identification unit that acquires a set of logs from a computing system that has been subjected to a cyberattack, and identifies, from the acquired set of logs, a trace indicating a result of the cyberattack by using history data indicating execution history of the cyberattack.

### CROSS-REFERENCE TO RELATED APPLICATION

This application is based upon and claims the benefit of priority from Japanese patent application No. 2022-208773, filed on Dec. 26, 2022, the disclosure of which is incorporated herein in its entirety by reference.

### BACKGROUND OF THE INVENTION

### 1. Field of the Invention

The present disclosure relates to an information processing apparatus and an information processing method for assisting in training to prepare for cyberattacks, and further relates to a computer-readable recording medium having recorded thereon a program for realizing the apparatus and the method.

### 2. Background Art

In recent years, cyberattacks targeting organizations have caused an increasing number of damages such as information leaks and business shutdowns, and there is a need to strengthen countermeasures against cyberattacks. In order to strengthen countermeasures against cyberattacks, it is essential to improve skills of system security personnel.

To achieve this, cyber security exercises have conventionally been conducted to improve skills of security personnel. Patent document (Japanese Patent Laid-Open Publication No. 2019-191670) discloses a system for executing cyber security exercises. Patent document proposes a system that implements cyber security exercises appropriate for the skill of each participant.

In the system disclosed in Patent document, first, an attack execution program is installed in each machine in a machine group that is an attack target. Then, the system disclosed in Patent document controls the attack execution program and executes a cyberattack against the machine group that is the attack target, in accordance with a prepared scenario. Upon the cyberattack being executed, each participant executes an operation to stop the execution of the cyberattack.

Thereafter, the system disclosed in Patent document collects from each machine an attack result log that indicates the result of the cyberattack (success/failure) and an operation log that indicates a response operation performed by the participant during the cyberattack, and displays the collected logs on a display screen. This allows the participant to judge whether or not the operation performed by the participant was appropriate.

Cyberattacks are often executed without being noticed by security personnel, and the personnel may not be able to perform response operations when a cyberattack is executed. In such cases, it is important to collect a log from each machine and find logs (hereinafter, “attack logs”) that provide traces of an incident based on the collected logs.

Therefore, if the aforementioned system disclosed in Patent document executes a cyberattack, then collects a log from each machine, and presents the collected logs, the participant can be trained to find attack logs that provide traces of the incident.

However, since the aforementioned system disclosed in Patent document can only present the collected logs, the participant needs to investigate and determine by themselves whether the logs he extracted as attack logs really are attack logs.

This is a great burden on the participant. For the participant to efficiently improve the skill, a system is necessary that automatically extracts attack logs that are correct solutions of the exercise from among the collected logs.

### SUMMARY OF INVENTION

An example object of the present disclosure is to identify traces of an incident out of logs collected from a machine group that has been subjected to a cyberattack, without manual intervention.

In order to achieve the above-described object, an information processing apparatus includes:
a trace identification unit that acquires a set of logs from a computing system that has been subjected to a cyberattack, and identifies, from the acquired set of logs, a trace indicating a result of the cyberattack by using history data indicating execution history of the cyberattack.

In addition, in order to achieve the above-described object, an information processing method includes:
a step of acquiring a set of logs from a computing system that has been subjected to a cyberattack, and identifying, from the acquired set of logs, a trace indicating a result of the cyberattack by using history data indicating execution history of the cyberattack.

Furthermore, in order to achieve the above-described object, a computer readable recording medium according to an example aspect of the invention is a computer readable recording medium that includes recorded thereon a program,
the program including instructions that cause the computer to carry out:
a step of acquiring a set of logs from a computing system that has been subjected to a cyberattack and identifying, from the acquired set of logs, a trace indicating a result of the cyberattack by using history data indicating execution history of the cyberattack.

As described above, according to the present disclosure, it is possible to identify traces of an incident out of logs collected from a machine group that has been subjected to a cyberattack, without manual intervention.

### BRIEF DESCRIPTION OF THE DRAWINGS

FIG. 1 is a configuration diagram illustrating a schematic configuration of an example of the information processing apparatus.

FIG. 2 is a configuration diagram illustrating a specific configuration of the example of the information processing apparatus.

FIG. 3 is a flowchart illustrating an example of the operation of the information processing apparatus.

FIG. 4 is a diagram illustrating an example of a configuration of the computing system and history data.

FIG. 5 is a diagram illustrating an example of logs acquired from the computing system.

FIG. 6 is a diagram illustrating an example of the attack command database.

FIG. 7 is a diagram illustrating examples of the solution templates.

FIG. 8 is a diagram illustrating examples of identified traces.

FIG. 9 is a diagram illustrating examples of the solution templates to which the identified traces are applied.

FIG. 10 is a configuration diagram illustrating a configuration of another example of the information processing apparatus.

FIG. 11 is a flowchart illustrating other example of the operation of the information processing apparatus.

FIG. 12 is a diagram illustrating an example of a participant's answer, examples of identified traces, and an example of a table for score calculation.

FIG. 13 is a block diagram illustrating an example of a computer that realizes the information processing apparatus.

### EXAMPLE EMBODIMENT

### First Example Embodiment

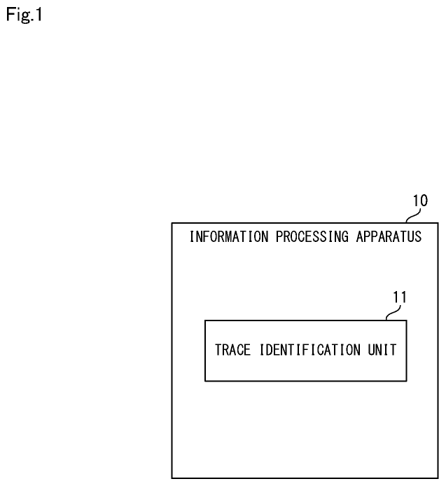

Hereinafter, an information processing apparatus, an information processing method, and a program according to the first example embodiment will be described with reference to FIGS. 1 to 9.

### [Apparatus Configuration]

First, a schematic configuration of the information processing apparatus according to the first example embodiment will be described with reference to FIG. 1. FIG. 1 is a configuration diagram illustrating a schematic configuration of an example of the information processing apparatus.

An information processing apparatus 10 illustrated in FIG. 1 is an apparatus for assisting in training to prepare for cyberattacks, i.e. a cyberattack training assisting apparatus. As illustrated in FIG. 1, the information processing apparatus 10 includes a trace identification unit 11.

The trace identification unit 11 first acquires a set of logs from a computing system that has been subjected to a cyberattack. The trace identification unit 11 then identifies traces indicating the results of the cyberattack from the acquired set of logs using history data indicating cyberattack execution history.

The information processing apparatus 10 can thus identify traces indicating the results of a cyberattack from a set of logs. According to the information processing apparatus 10, traces of an incident can be identified from logs collected from a machine group that has been subjected to a cyberattack, without manual intervention.

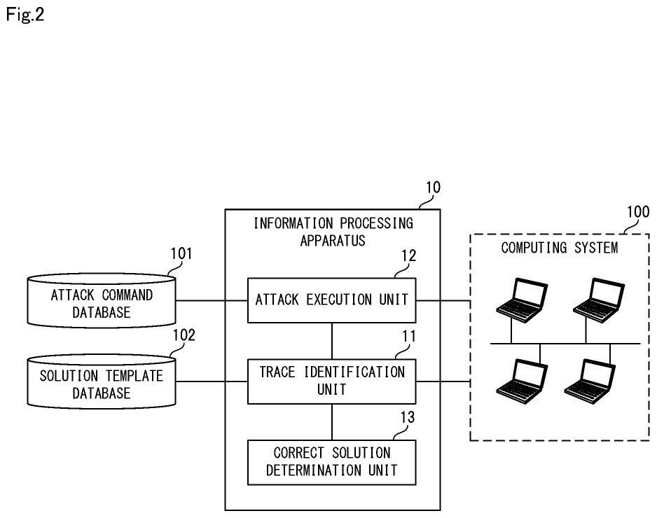

Subsequently, a configuration and functions of the information processing apparatus 10 according to the first example embodiment will be described in detail with reference to FIG. 2. FIG. 2 is a configuration diagram illustrating a specific configuration of the example of the information processing apparatus.

In the first example embodiment, the information processing apparatus 10 is connected, via a network or the like, to a computing system 100, an attack command database 101, and a solution template database 102 such that data communication is possible, as illustrated in FIG. 2.

The computing system 100 is a system that includes a large number of terminal devices, server devices, and the like. The attack command database 101 and the solution template database 102 will be described later.

As illustrated in FIG. 2, the information processing apparatus 10 includes an attack execution unit 12 and a correct solution determination unit 13 in addition to the aforementioned trace identification unit 11. The attack execution unit 12 executes a cyberattack, which is constituted by a plurality of stages, on the computing system 100 and generates history data.

Specifically, the attack execution unit 12 first generates a process of a cyberattack constituted by a plurality of stages, and executes the generated process on the computing system 100. The execution of the process causes a simulation of cyberattack to be executed on the computing system 100. A process of a cyberattack can be generated using a technology disclosed in International Publication No. 2020/255359.

When using the above technology, the attack execution unit 12 first acquires information that identifies the number of set stages and information regarding the environment in which a scenario is executed (operating system type, IP address of an attack target, network topology etc.). Next, the attack execution unit 12 selects processing to be executed in each stage from a database in which elements of processing executable in respective stages are registered, and generates a scenario of a targeted attack.

Processing performed in each stage is defined by a tactic in the stage, a technology used in the stage, and software required to execute processing in the stage, and the tactic, technology, and software correspond to the aforementioned elements.

After the attack execution unit 12 has executed the aforementioned process, execution history is generated. The generated execution history serves as history data. The execution history includes an attack command for each stage of the cyberattack.

The trace identification unit 11 in the first example embodiment first collects a log from each terminal device in the computing system 100 that has been subjected to the simulation of cyberattack. The logs can be collected using an existing tool such as CDIR-Collector, for example.

Subsequently, the trace identification unit 11 compares the history data with solution templates and identifies information (hereinafter referred to as “trace information”) that indicates traces of the attack based on the attack command included in the history data. The solution templates refer to templates in which information indicating a trace of an attack based on an attack command is registered for each attack command. The solution templates are stored in the solution template database 102. Further, based on the identified information, the trace identification unit 11 identifies traces of the cyberattack from the set of logs collected from the computing system 100.

Specifically, the trace identification unit 11 compares the attack command included in the history data with the attack command database 101 in which solution templates corresponding to respective attack commands are registered. Since the solution templates corresponding to respective attack commands are registered in the attack command database 101, the trace identification unit 11 selects a solution template corresponding to the attack command through the comparison. Then, the trace identification unit 11 applies the selected solution template to the collected log set and identifies the traces of the cyberattack.

A correct solution determination unit 13 compares the traces identified by the trace identification unit 11 with preset correct solution conditions, and determines whether or not the identified traces are correct based on the comparison results. In the first example embodiment, the correct solution conditions are represented by a combination of types of traces. Therefore, the correct solution determination unit 13 determines that the extracted traces are correct if all types of the identified traces are included in the combination represented by the correct solution condition.

### [Apparatus Operation]

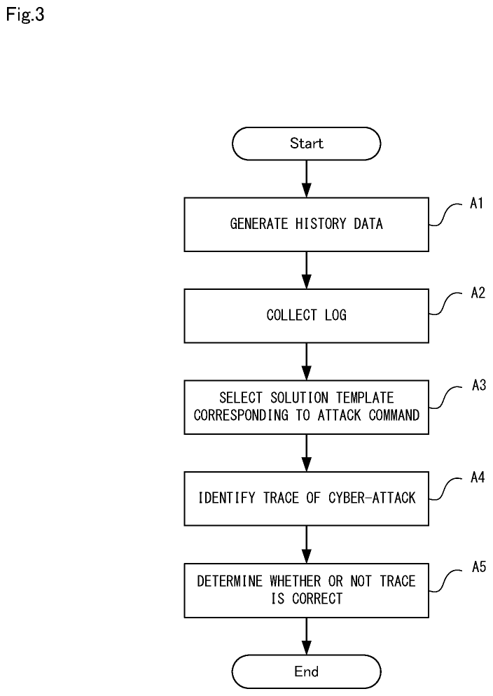

Next, an operation of the information processing apparatus 10 will be described with reference to FIG. 3. FIG. 3 is a flowchart illustrating an example of the operation of the information processing apparatus. The following description references FIGS. 1 and 2 as necessary. In the first example embodiment, an information processing method is implemented by operating the information processing apparatus 10. Accordingly, the following description of the operation of the information processing apparatus 10 replaces a description of the information processing method according to the first example embodiment.

First, as illustrated in FIG. 3, the attack execution unit 12 executes a cyberattack, which is constituted by a plurality of stages, on the computing system 100 and generates history data (step A1).

Next, the trace identification unit 11 collects a log from each terminal device in the computing system 100 that has been subjected to the simulation of cyberattack in step A1 (step A2).

Next, the trace identification unit 11 compares an attack command included in the history data with the attack command database 101 and selects a solution template corresponding to the attack command (step A3).

Next, the trace identification unit 11 applies the solution template selected in step A3 to a set of logs collected in step A2, and identifies a trace of the cyberattack executed in step A1 (step A4).

Thereafter, the correct solution determination unit 13 compares the trace identified in step A4 with the preset correct solution conditions and determines whether or not the identified trace is correct based on the comparison result (step A5).

### Specific Example

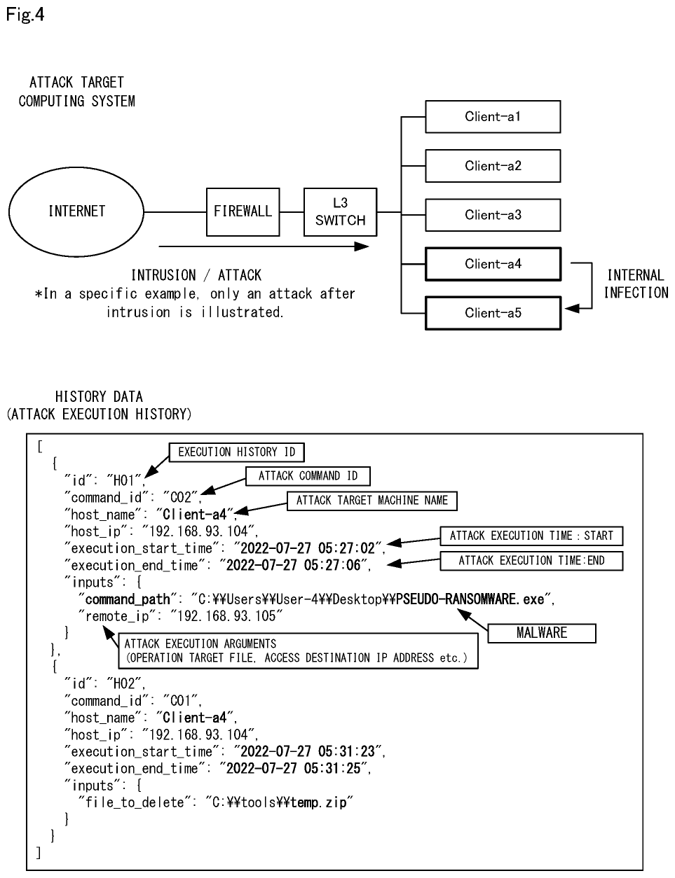

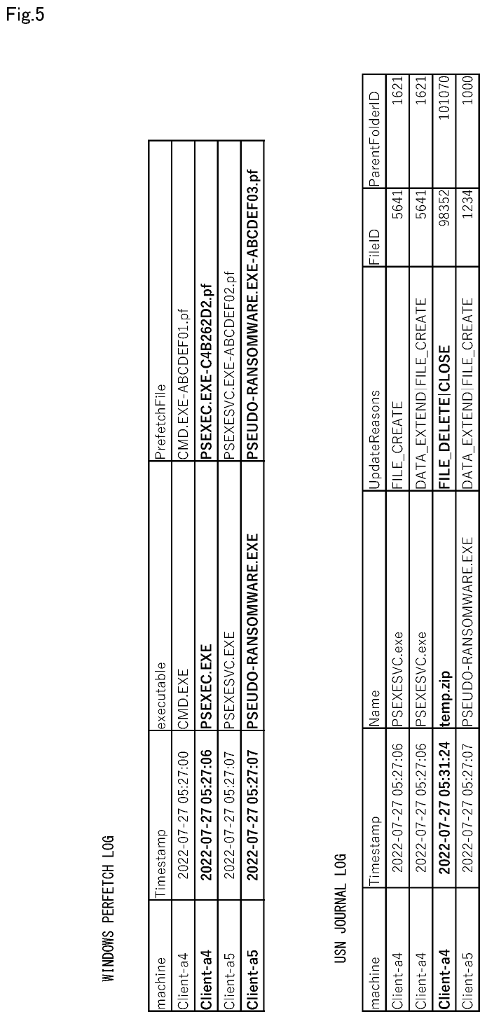

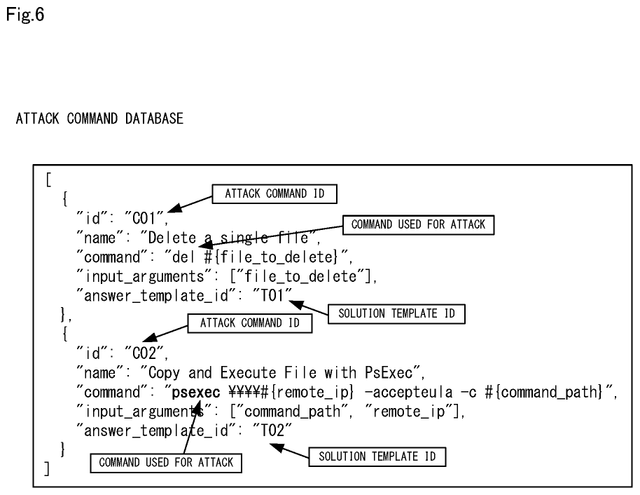

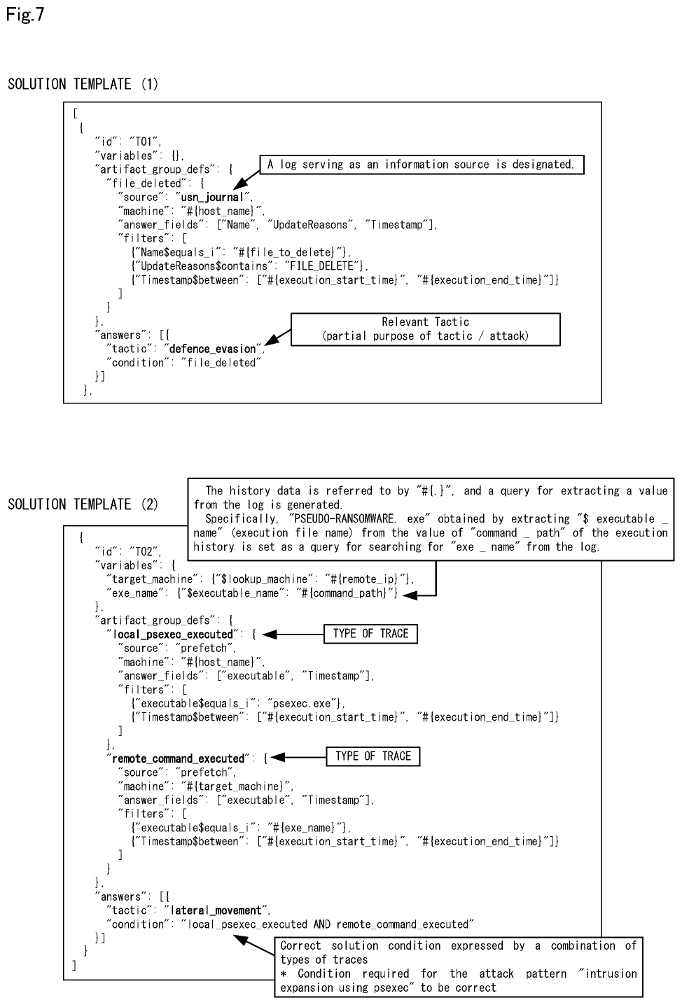

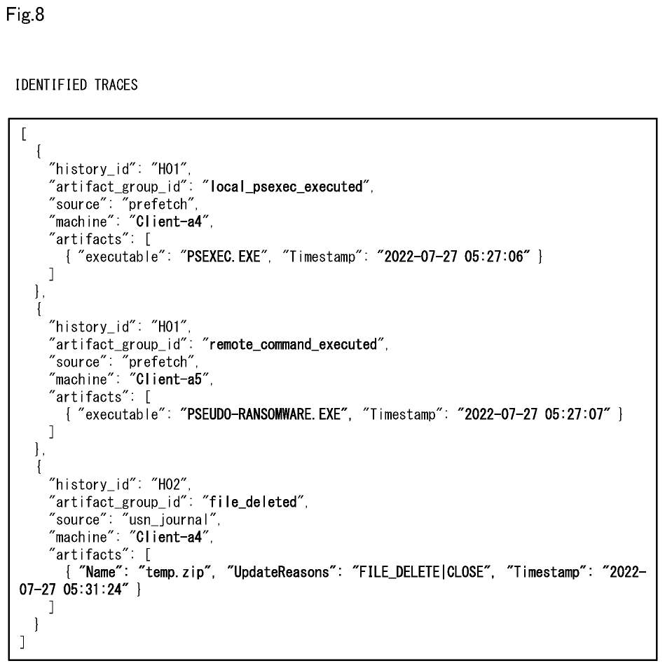

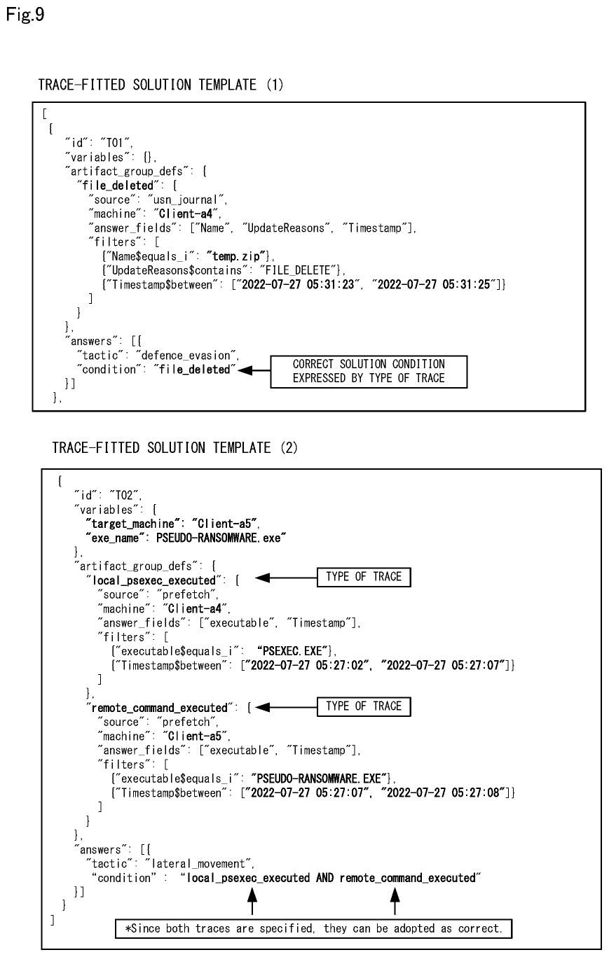

Subsequently, a specific example of processing performed by the information processing apparatus 10 according to the first example embodiment will be described with reference to FIGS. 4 to 9. FIG. 4 is a diagram illustrating an example of a configuration of the computing system and history data. FIG. 5 is a diagram illustrating an example of logs acquired from the computing system. FIG. 6 is a diagram illustrating an example of the attack command database. FIG. 7 is a diagram illustrating examples of the solution templates. FIG. 8 is a diagram illustrating examples of identified traces. FIG. 9 is a diagram illustrating examples of the solution templates to which the identified traces are applied.

### [Step A1]

In a specific example, the attack execution unit 12 executes a simulation of cyberattack on the computing system illustrated in the upper part of FIG. 4. As a result, Client-a4 is infected with malware, and internal malware infection occurs from Client-a4 to Client-a5. After the attack, history data (attack execution history) illustrated in the lower part of FIG. 4 is generated.

As illustrated in FIG. 4, the history data includes an execution history ID, an attack command ID, an attack target machine name, attack execution time (start and end), a malware name, attack execution arguments (operation target file, access destination IP address etc.). The execution history ID is an ID imparted to each stage of the attack.

### [Step A2]

The trace identification unit 11 collects logs illustrated in FIG. 5 from the terminal devices in the computing system illustrated in FIG. 4, using CDIR-Collector. In the example in FIG. 5, logs of Client-a4 and Client-a5 that have been infected with malware are collected.

### [Step A3]

The trace identification unit 11 searches for the attack command database 101 illustrated in FIG. 6 using the attack command ID included in the history data illustrated in the lower part of FIG. 4, and identifies a corresponding solution template.

Specifically, the trace identification unit 11 identifies a solution template ID “T02” from a relevant portion of the attack command database 101 illustrated in FIG. 5, using the attack command ID “C02” corresponding to the execution history ID “H01” illustrated in FIG. 4. Similarly, the trace identification unit 11 identifies a solution template ID “T01” from a relevant portion of the attack command database 101, using the attack command ID “C01” corresponding to the execution history ID “H02” illustrated in FIG. 4.

### [Step A4]

Next, the trace identification unit 11 applies the solution templates “T01” and “T02” selected in step A3 and illustrated in FIG. 7 to the set of logs illustrated in FIG. 5.

Specifically, the trace identification unit 11 extracts corresponding information (target host machine name, arguments of the attack commands, attack execution time etc.) from the history data using variable (“#{ . . . }”) in the selected solution templates, and sets the extracted information as a query.

The trace identification unit 11 then extracts corresponding data from the set of logs using the query. In this specific example, data denoted by bold letters in FIG. 5 is extracted. The trace identification unit 11 also extracts remaining variables (corresponding tactic, type of trace etc.) in the selected solution template, and extracts values corresponding to the extracted variables from the data previously extracted from the set of logs. All of the thus-extracted values serve as traces of the cyberattack illustrated in FIG. 8. The results of applying the traces identified in step A4 to the solution templates selected in step A3 are illustrated in an example in FIG. 9.

### [Step A5]

The correct solution determination unit 13 determines whether or not the traces identified in step A4 satisfy any of the preset correct solution conditions. The correct solution conditions are defined as values of “condition” in the solution templates illustrated in FIGS. 7 and 9. In FIGS. 7 and 9, a solution template (1) expresses a correct solution condition as a type of trace. A solution template (2) expresses correct solution conditions by combining types of traces stated in each solution template.

The correct solution determination unit 13 then outputs a pair of traces that satisfy the correct solution conditions and the logs of the terminals that were attack targets as content of cyberattack exercises. Meanwhile, the correct solution determination unit 13 discards traces that do not satisfy the correct solution conditions, together with the logs, as they cannot be used for the exercises because solutions cannot be automatically acquired.

As described above, according to the information processing apparatus 10, traces of an incident can be identified from logs collected from a machine group that has been subjected to a cyberattack, without manual intervention, and content for cyberattack exercises can be automatically generated. Furthermore, according to the information processing apparatus 10, correct solutions of content for the exercise content can also be automatically generated.

### [Program]

It suffices for the program in the first example embodiment to be a program that causes a computer to carry out steps A1 to A6 illustrated in FIG. 3. By installing this program on a computer and executing the program, the information processing apparatus 10 and the information processing method can be realized. In this case, one or more processors of the computer function and perform processing as the trace identification unit 11, the attack execution unit 12 and the correct solution determination unit 13. As examples of the computer, a general-purpose PC, a smartphone, a tablet-type terminal device, an embedded computer, and the like can be mentioned.

Furthermore, the program in the first example embodiment may be executed by a computer system constructed from a plurality of computers. In this case, the computers may each function as one of the trace identification unit 11, the attack execution unit 12 and the correct solution determination unit 13, for example.

### Second Example Embodiment

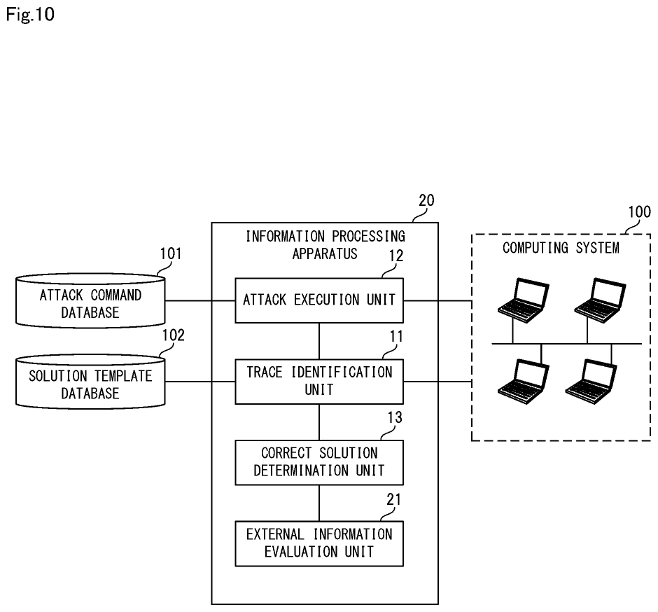

Next, an information processing apparatus, an information processing method, and a program according to the second example embodiment will be described with reference to FIGS. 10 to 12.

### [Apparatus Configuration]

First, a configuration of another example of the information processing apparatus will be described with reference to FIG. 10. FIG. 10 is a configuration diagram illustrating a configuration of another example of the information processing apparatus.

An information processing apparatus 20 illustrated in FIG. 10 is an apparatus for assisting in training to prepare for cyberattacks, i.e. a cyberattack training assisting apparatus, similar to the information processing apparatus 10 illustrated in FIGS. 1 and 2.

As illustrated in FIG. 10, the information processing apparatus 20 includes a trace identification unit 11, an attack execution unit 12, and a correct solution determination unit 13, and is therefore configured similarly to the information processing apparatus 10 in this regard. Note that the information processing apparatus 20 also includes an external information evaluation unit 21. The following description focuses on differences from the first example embodiment.

The external information evaluation unit 21 compares at least one trace of a cyberattack input as external information with a trace identified by the trace identification unit 11 or a trace determined to be correct by the correct solution determination unit 13. The external information evaluation unit 21 then calculates the proportion by which those compared traces match based on the comparison results, and sets the calculated proportion as a score. Note that although the score is calculated by using the calculated proportion as-is in the second example embodiment, the score may be calculated with any other calculation method.

Specifically, the external information evaluation unit 21 receives a participant's answer to the cyber security exercise as external information. The answer includes a plurality of traces, and each trace includes items such as the location, date and time, an artifact (target of the trace) of an attack trace discovered by the participant, content of the attack indicated by the trace, the purpose of the attack, and so on. The participant can also input their own answer to an answer input form displayed on a screen of the terminal device. In this case, the terminal device transmits the answer input to the answer input form to the information processing apparatus 20.

Next, the external information evaluation unit 21 checks the answer with the traces identified by the trace identification unit 11 or the traces determined to be correct by the correct solution determination unit 13 to determine whether or not each of the items coincide. The external information evaluation unit 21 then calculates, for example, the proportion of traces all of the items of which coincide, of the traces included in the answer, and sets the calculated proportion as a score.

### [Apparatus Operation]

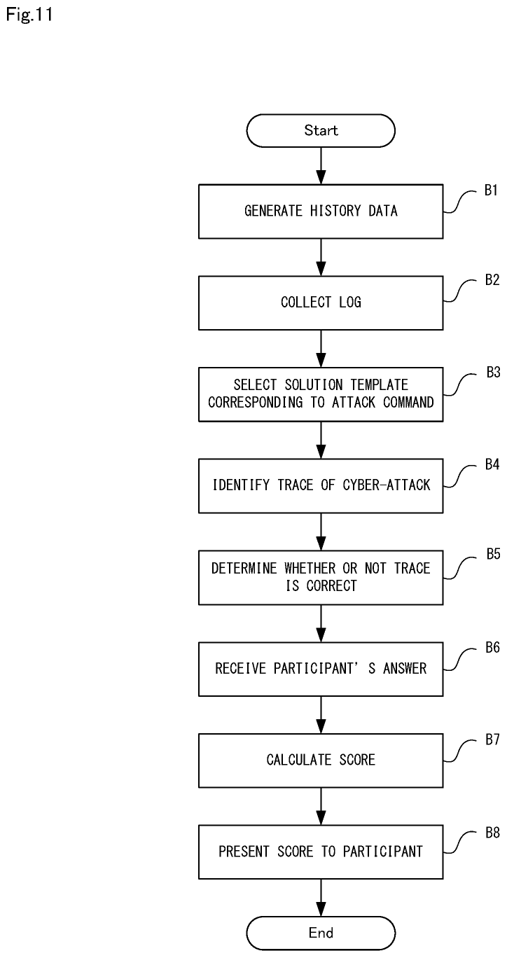

Next, an operation of the information processing apparatus 20 will be described with reference to FIG. 11. FIG. 11 is a flowchart illustrating other example of the operation of the information processing apparatus. The following description references FIG. 10 as necessary. In the second example embodiment, an information processing method is implemented by operating the information processing apparatus 20. Accordingly, the following description of the operation of the information processing apparatus 20 replaces a description of the information processing method according to the second example embodiment.

First, as illustrated in FIG. 11, the attack execution unit 12 executes a cyberattack, which is constituted by a plurality of stages, on the computing system 100 and generates history data (step B1).

Next, the trace identification unit 11 collects a log from each terminal device in the computing system 100 that has been subjected to the simulation of cyberattack in step B1 (step B2).

Next, the trace identification unit 11 compares an attack command included in the history data with the attack command database 101 and selects a solution template corresponding to the attack command (step B3).

Next, the trace identification unit 11 applies the solution template selected in step B3 to a set of logs collected in step B2, and identifies a trace of the cyberattack executed in step B1 (step B4)

Next, the correct solution determination unit 13 compares the trace identified in step B4 with preset correct solution conditions and determines whether or not the identified trace is correct based on the comparison result (step B5). Note that steps B1 to B5 above are the same as steps A1 to A5 illustrated in FIG. 3.

Next, the external information evaluation unit 21 receives the participant's answer to the cyber security exercise as external information (step B6). Specifically, for example, the terminal device of the participant or the like transmits the answer to the exercise via the Internet, and thus, in step B6, the external information evaluation unit 21 receives the transmitted answer.

Next, the external information evaluation unit 21 compares the answer to the exercise received in step B6 with the trace identified in step B4 or the trace determined to be correct in step B5, and calculates the proportion by which these compared traces match as a score (step B7).

Thereafter, the external information evaluation unit 21 transmits the score calculated in step B7 to the participant's terminal device or the like, and presents the score to the participant (step B8).

### Specific Example

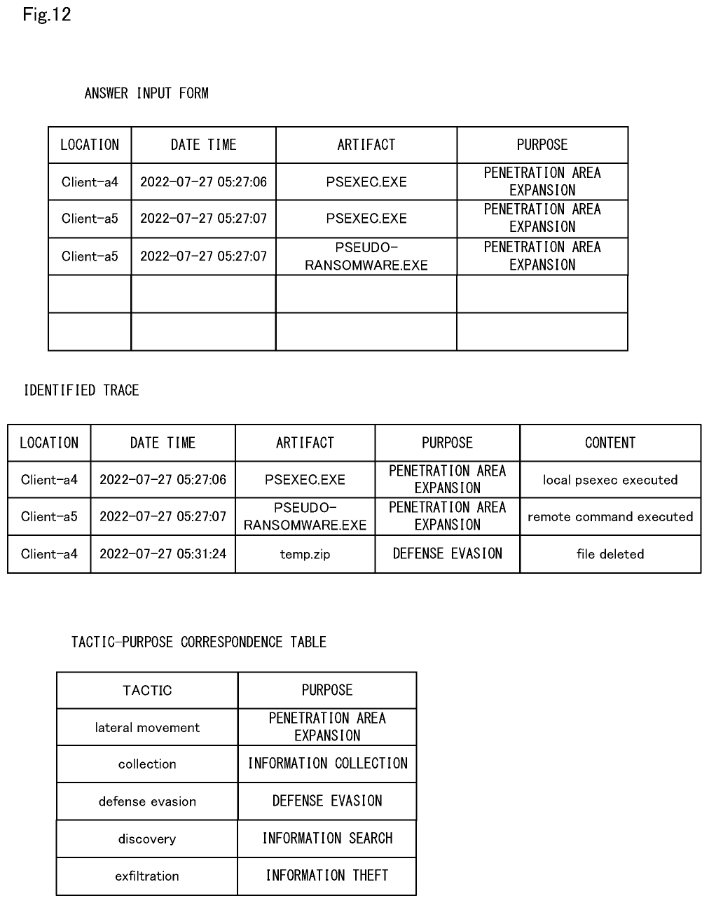

Subsequently, a specific example of processing performed by the information processing apparatus 20 according to the second example embodiment will be described with reference to FIG. 12. FIG. 12 is a diagram illustrating an example of a participant's answer, examples of identified traces, and an example of a table for score calculation. In the following specific example, steps B6 and B7 are mainly described.

First, the participant inputs their answer to the answer input form displayed on the screen of the terminal device. The upper part of FIG. 12 shows an example of the answer input form with the answers input. The answer input form includes, as items, the location, date and time, and artifact of traces of attacks discovered by the participants, as well as purposes of the attacks.

The traces identified in step B4 are as illustrated in the middle part of FIG. 12. Each trace includes, as items, the location, date and time, and artifact of the trace of the attack discovered by the participants, as well as a purpose of the attack and the content of the attack. In this specific example, the value of the purpose of each attack is obtained by converting the “tactic” value in the correct solution conditions (see FIG. 9) using a tactic-purpose correspondence table (lower part of FIG. 12). The value of the attack content is obtained from the “artifact_group_id” value of the identified trace (see FIG. 8).

For each record in the answer input form illustrated in the upper part of FIG. 12, the external information evaluation unit 21 determines whether or not the value of each item included in the record matches the value of the corresponding item of the trace illustrated in the middle part of FIG. 12, and identifies a record in which the values of all items coincide. As a result of the determination, all of the values of the items coincide in two of the three records. Thus, the external information evaluation unit 21 calculates of 67 (≈⅔×100) points as a score. Thereafter, the external information evaluation unit 21 transmits the calculated score to the terminal device of the participant and presents the score to the participant.

Thus, if the participant submits an answer to the content for the exercise, the information processing apparatus 20 can evaluate the answer. According to the information processing apparatus 20, the participant can promote learning on their own using the cyber security exercise.

### [Program]

It suffices for the program in the second example embodiment to be a program that causes a computer to carry out steps B1 to B8 illustrated in FIG. 11. By installing this program on a computer and executing the program, the information processing apparatus 20 and the information processing method can be realized. In this case, one or more processors of the computer function and perform processing as the trace identification unit 11, the attack execution unit 12, the correct solution determination unit 13 and the external information evaluation unit 21. As examples of the computer, a general-purpose PC, a smartphone, a tablet-type terminal device, an embedded computer, and the like can be mentioned.

Furthermore, the program in the second example embodiment may be executed by a computer system constructed from a plurality of computers. In this case, the computers may each function as one of the trace identification unit 11, the attack execution unit 12, the correct solution determination unit 13 and the external information evaluation unit 21, for example.

### [Effects]

As described above, according to the example embodiments 1 and 2, exercise problems and correct solutions for cyber security exercises can be automatically generated. This can reduce the preparation period and operational cost for the exercises. Furthermore, the human cost of creating exercise problems and correct solutions can also be reduced. As a result, different types of exercise content can be provided to a large number of participants.

Since costs can be reduced as mentioned above, exercise problems and correct solutions can be repeatedly provided to the same participant. That is, new exercise problems and correct solutions can be easily generated, and it is therefore possible to provide a new similar exercise to a participant who has once taken an exercise. Accordingly, the participant can review the exercise content by retaking the exercise and acquire skills more reliably.

Furthermore, skill is reliably improved by, for example, regularly conducting exercises with different exercise problems each time for the same the participant. If the same exercise problems are used every time, the participant is able to memorize the correct solutions or use notes left when he took the exercise last time, which may result in inability to measure the true ability of the participant to respond. However, according to the example embodiments 1 and 2, no such problem will occur. In addition, regular and continuous exercise services can be provided at low cost, which enables business capable of earning sustainable profits.

According to the example embodiments 1 and 2, it is also possible to update only the date and time of the same exercise problems and correct solutions as those implemented previously, and make them into new exercise problems and correct solutions. For example, if a simulation of cyberattack executed in the past is re-executed and logs are collected again to generate traces, the latest exercise problems and correct solutions with date and time close to the exercise implementation date are automatically generated.

### [Physical Configuration]

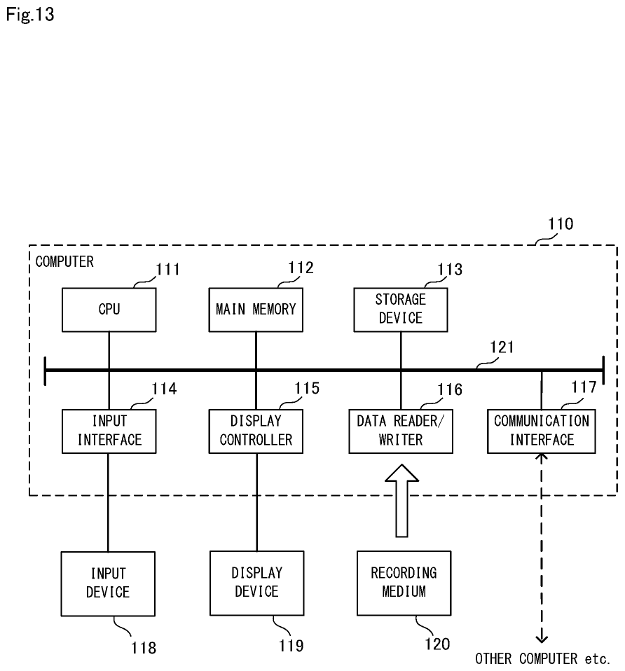

Using FIG. 13, the following describes a computer that realizes the information processing apparatus by executing the program according to the first and second example embodiment. FIG. 13 is a block diagram illustrating an example of a computer that realizes the information processing apparatus.

As shown in FIG. 13, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information processing apparatus according to the example embodiment can also be realized by using items of hardware, for example, electric circuit that respectively correspond to the components rather than the computer in which the program is installed. Furthermore, a part of the information processing apparatus may be realized by the program, and the remaining part of the information processing apparatus may be realized by hardware. In the example embodiment, the computer is not limited to the computer illustrated in FIG. 13.

A part or an entirety of the above-described example embodiment can be represented by (Supplementary Note 1) to (Supplementary Note 18) described below but is not limited to the description below.

### (Supplementary Note 1)

An information processing apparatus comprising:
a trace identification unit that acquires a set of logs from a computing system that has been subjected to a cyberattack, and identifies, from the acquired set of logs, a trace indicating a result of the cyberattack by using history data indicating execution history of the cyberattack.

### (Supplementary Note 2)

The information processing apparatus according to Supplementary Note 1, further comprising:
an attack execution unit that executes a cyberattack constituted by a plurality of stages on the computing system, and generates the history data.

### (Supplementary Note 3)

The information processing apparatus according to Supplementary Note 1,
wherein the history data includes attack commands for the respective stages of the cyberattack, and
the trace identification unit compares the history data with a template in which information indicating a trace of an attack for each of the attack commands is registered, identifies information indicating the trace of the attack based on the attack command included in the history data, and identifies the trace of the cyberattack from the set of logs based on the identified information.

### (Supplementary Note 4)

The information processing apparatus according to Supplementary Note 1, further comprising:
a correct solution determination unit that compares the identified trace with a preset correct solution condition, and determines based on a result of the comparison whether or not the identified trace is correct.

### (Supplementary Note 5)

The information processing apparatus according to Supplementary Note 4,
wherein the correct solution condition is represented by a combination of types of traces, and
the correct solution determination unit determines that the identified trace is correct if all type of the identified trace is included in the combination representing the correct solution condition.

### (Supplementary Note 6)

The information processing apparatus according to Supplementary Note 4, further comprising:
an external information evaluation unit that compares at least one trace of a cyberattack that is input as external information with the trace identified by the trace identification unit or with the trace determined to be correct by the correct solution determination unit, and calculates a score based on a proportion by which the compared traces match.

### (Supplementary Note 7)

An information processing method comprising:
a trace identification step of acquiring a set of logs from a computing system that has been subjected to a cyberattack, and identifying, from the acquired set of logs, a trace indicating a result of the cyberattack by using history data indicating execution history of the cyberattack.

### (Supplementary Note 8)

The information processing apparatus according to Supplementary Note 7, further comprising:
an attack execution step of executing a cyberattack constituted by a plurality of stages on the computing system, and generating the history data.

### (Supplementary Note 9)

The information processing method according to Supplementary Note 7,
wherein the history data includes attack commands for the respective stages of the cyberattack, and
in the trace identification step, comparing the history data with a template in which information indicating a trace of an attack for each of the attack commands is registered, identifying information indicating the trace of the attack based on the attack command included in the history data, and identifying the trace of the cyberattack from the set of logs based on the identified information.

### (Supplementary Note 10)

The information processing method according to Supplementary Note 7, further comprising:
a correct solution determination step of comparing the identified trace with a preset correct solution condition, and determining based on a result of the comparison whether or not the identified trace is correct.

### (Supplementary Note 11)

The information processing method according to Supplementary Note 10,
wherein the correct solution condition is represented by a combination of types of traces, and
in the correct solution determination step, determining that the identified trace is correct if all type of the identified trace is included in the combination representing the correct solution condition.

### (Supplementary Note 12)

The information processing method according to Supplementary Note 10, further comprising:
an external information evaluation step of comparing at least one trace of a cyberattack that is input as external information with the trace identified in the trace identification step or with the trace determined to be correct in the correct solution determination step, and calculating a score based on a proportion by which the compared traces match.

### (Supplementary Note 13)

A computer readable recording medium that includes a program recorded thereon, the program including instructions that causes a computer to carry out:
a trace identification step of acquiring a set of logs from a computing system that has been subjected to a cyberattack and identifying, from the acquired set of logs, a trace indicating a result of the cyberattack by using history data indicating execution history of the cyberattack.

### (Supplementary Note 14)

The computer readable recording medium according to Supplementary Note 13, the program further including instructions that cause the computer to carry out:
an attack execution step of executing a cyberattack constituted by a plurality of stages on the computing system, and generating the history data.

### (Supplementary Note 15)

The computer readable recording medium according to Supplementary Note 13,
wherein the history data includes attack commands for the respective stages of the cyberattack, and
in the trace identification step, comparing the history data is compared with a template in which information indicating a trace of an attack for each of the attack commands is registered, identifying information indicating the trace of the attack based on the attack command included in the history data, and identifying the trace of the cyberattack from the set of logs based on the identified information.

### (Supplementary Note 16)

The computer readable recording medium according to Supplementary Note 13, the program further including instructions that cause the computer to carry out:
a correct solution determination step of comparing the identified trace with a preset correct solution condition, and determining based on a result of the comparison whether or not the identified trace is correct.

### (Supplementary Note 17)

The computer readable recording medium according to Supplementary Note 16,
wherein the correct solution condition is represented by a combination of types of traces, and
in the correct solution determination step, determining that the identified trace is correct if all type of the identified trace is included in the combination representing the correct solution condition.

### (Supplementary Note 18)

The computer readable recording medium according to Supplementary Note 16, the program further including instructions that cause the computer to carry out:
an external information evaluation step of comparing at least one trace of a cyberattack that is input as external information with the trace identified in the trace identification step or with the trace determined to be correct in the correct solution determination step, and calculating a score based on a proportion by which the compared traces match.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the invention, i it is possible to identify traces of an incident out of logs collected from a machine group that has been subjected to a cyberattack, without manual intervention. The present disclosure is useful for a system for training against a cyberattack.

### REFERENCE SIGNS LIST

10 Information processing apparatus (first example embodiment)
11 Trace identification unit
12 Attack execution unit
13 Correct solution determination unit
20 Information processing apparatus (second example embodiment)
21 External information evaluation unit
100 Computing system
101 Attack command database
102 Solution template database
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information processing apparatus comprising:
at least one memory storing instructions; and
at least one processor configured to execute the instructions to:
acquire a set of logs from a computing system that has been subjected to a cyberattack, and identify, from the acquired set of logs, a trace indicating a result of the cyberattack by using history data indicating execution history of the cyberattack.

2. The information processing apparatus according to claim 1,
further at least one processor configured to execute the instructions to:
execute a cyberattack constituted by a plurality of stages on the computing system, and generates the history data.

3. The information processing apparatus according to claim 1,
wherein the history data includes attack commands for the respective stages of the cyberattack, and
further at least one processor configured to execute the instructions to:
compare the history data with a template in which information indicating a trace of an attack for each of the attack commands is registered, identify information indicating the trace of the attack based on the attack command included in the history data, and identify the trace of the cyberattack from the set of logs based on the identified information.

4. The information processing apparatus according to claim 1, further comprising:
further at least one processor configured to execute the instructions to:
compare the identified trace with a preset correct solution condition, and determine based on a result of the comparison whether or not the identified trace is correct.

5. The information processing apparatus according to claim 4,
wherein the correct solution condition is represented by a combination of types of traces, and
further at least one processor configured to execute the instructions to:
determine that the identified trace is correct if all type of the identified trace is included in the combination representing the correct solution condition.

6. The information processing apparatus according to claim 4,
further at least one processor configured to execute the instructions to:
compare at least one trace of a cyberattack that is input as external information with the trace identified by the trace identification unit or with the trace determined to be correct by the correct solution determination unit, and calculate a score based on a proportion by which the compared traces match.

7. An information processing method comprising:
acquiring a set of logs from a computing system that has been subjected to a cyberattack, and identifying, from the acquired set of logs, a trace indicating a result of the cyberattack by using history data indicating execution history of the cyberattack.

8. The information processing apparatus according to claim 7, further comprising:
executing a cyberattack constituted by a plurality of stages on the computing system, and generating the history data.

9. The information processing method according to claim 7,
wherein the history data includes attack commands for the respective stages of the cyberattack, and
in the identifying the trace, comparing the history data with a template in which information indicating a trace of an attack for each of the attack commands is registered, identifying information indicating the trace of the attack based on the attack command included in the history data, and identifying the trace of the cyberattack from the set of logs based on the identified information.

10. The information processing method according to claim 7, further comprising:
comparing the identified trace with a preset correct solution condition, and determining based on a result of the comparison whether or not the identified trace is correct.

11. The information processing method according to claim 10,
wherein the correct solution condition is represented by a combination of types of traces, and
in the determining, determining that the identified trace is correct if all type of the identified trace is included in the combination representing the correct solution condition.

12. The information processing method according to claim 10, further comprising:
comparing at least one trace of a cyberattack that is input as external information with the trace identified in the trace identification step or with the trace determined to be correct in the correct solution determination step, and calculating a score based on a proportion by which the compared traces match.

13. A non-transitory computer readable recording medium that includes a program recorded thereon, the program including instructions that causes a computer to carry out:
acquiring a set of logs from a computing system that has been subjected to a cyberattack and identifying, from the acquired set of logs, a trace indicating a result of the cyberattack by using history data indicating execution history of the cyberattack.

14. The non-transitory computer readable recording medium according to claim 13, the program further including instructions that cause the computer to carry out:
executing a cyberattack constituted by a plurality of stages on the computing system, and generating the history data.

15. The non-transitory computer readable recording medium according to claim 13,
wherein the history data includes attack commands for the respective stages of the cyberattack, and
in the identifying the trace, comparing the history data is compared with a template in which information indicating a trace of an attack for each of the attack commands is registered, identifying information indicating the trace of the attack based on the attack command included in the history data, and identifying the trace of the cyberattack from the set of logs based on the identified information.

16. The non-transitory computer readable recording medium according to claim 13, the program further including instructions that cause the computer to carry out:
comparing the identified trace with a preset correct solution condition, and determining based on a result of the comparison whether or not the identified trace is correct.

17. The non-transitory computer readable recording medium according to claim 16,
wherein the correct solution condition is represented by a combination of types of traces, and
in the determining, determining that the identified trace is correct if all type of the identified trace is included in the combination representing the correct solution condition.

18. The non-transitory computer readable recording medium according to claim 16, the program further including instructions that cause the computer to carry out:
comparing at least one trace of a cyberattack that is input as external information with the trace identified in the trace identification step or with the trace determined to be correct in the correct solution determination step, and calculating a score based on a proportion by which the compared traces match.
